(19) United States
(12) Patent Application Publication
(10) Pub. No.: US 2005/0209000 A1
(43) Pub. Date: Sep. 22, 2005

(54) Game information processing system

(76) Inventors: Chisaki Kusajima, Tokyo (JP); Junichi Miyamoto, Tokyo (JP); Shuhei Fujiki, Tokyo (JP); Takatsugu Ehara, Tokyo (JP); Takumi Hori, Tokyo (JP); Masahide Kodaira, Tokyo (JP); Ryuji Namiki, Tokyo (JP); Toshiyuki Kuratsuji, Tokyo (JP); Hirofumi Sawai, Tokyo (JP); Toshiaki Tamesue, Tokyo (JP); Yoshihiro Ito, Tokyo (JP); Ryuhei Onitsuka, Tokyo (JP); Atsushi Kitahara, Tokyo (JP); Shinichi Furuhashi, Tokyo (JP); Jiro Yoshida, Tokyo (JP); Youichi Tanaami, Tokyo (JP); Tomohiro Kaneko, Tokyo (JP); Toshiyuki Kaji, Tokyo (JP); Hiroaki Tsuji, Tokyo (JP); Yutaka Okunoki, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/011,135

(22) Filed: Dec. 15, 2004

(30) Foreign Application Priority Data
Dec. 15, 2003 (JP) 2003-415957
Feb. 20, 2004 (JP) 2004-043776

(51) Int. Cl. A63F 13/00

(52) U.S. Cl. 463/41; 463/25

(57) ABSTRACT

Provided is a game machine including a portable phone terminal having a non-contact IC chip including an electronic money storage unit and a game point storage unit; an electronic money processing terminal capable of downloading, in a non-contact manner, to an electronic money amount storage unit the amount of electronic money purchased; a selection unit for selecting whether to conduct the settlement for executing the game application program based on the electronic money or the game points; a processing unit enabling the input of the amount of electronic money or game points necessary in executing the game application program to the settlement processing unit from the respective storage units of the IC chip, and a point generation unit for generating the acquired points according to the game execution status.

### BACKGROUND

1. Field of the Invention

The present invention relates to a game information processing system employing an information terminal comprising an IC circuit suitable for executing, for instance, a game application with an electronic game machine of a game arcade.

2. Description of the Related Art

As this type of system, for example, there is the system disclosed in Japanese Patent Laid-Open Publication No. 2000-207470. This is a system comprising a server for managing the operation of the game system, and has a means for issuing and a means for communicating a game pattern or game execution authority to an IC card; and a database for accumulating the log information relating to the game pattern or game execution authority received or issued from the terminal, game execution results with the IC card, and information relating to the user's point exchange. As a result of analyzing the contents of the database, this system is able to generate a game parameter defining the game level and game points and transmitting this to the foregoing terminal.

Further, with the likes of a conventional game device, game points were generated when electronic commerce such as electronic game play was executed. These game points are appropriately generated according to the number of game plays, inserted amount, game results and other game play modes. A simple electronic point service exclusive to a single company employing a single point value has been widely provided from the past. Further, a service of using a single electronic point service in a plurality of companies, or converting this to a point value of other electronic point services has also been widely provided from the past.

As a conventional example relating to this technology, Japanese Patent Laid-Open Publication No. 2002-222353 discloses a point service system having a computer which searches a storage means storing a point distribution ratio table based on the input user identification data, removes a prescribed point distribution ratio table, divides the parent points provided to the user based on the distribution ratio designated with the removed point distribution ratio table, and transferring the distributed points to the respective sections designated with the point distribution table.

### SUMMARY OF THE INVENTION

Nevertheless, with a conventional game information processing system employing an IC card, no consideration is given to the relationship with the recently developing electronic money.

Further, with a conventional point transfer service, although it is authorizing the parent points to be transferred to the respective sections on the one hand, there is no command for prohibiting the transfer of points, and, as a result, there is a problem in that this will authorize the transfer/exchange of points between competing companies.

Further, pursuant to the development of networks, game devices of other companies and game devices of different tiles of the same company, although the game programs thereof are different, are being connected via the same network. Nevertheless, although there were demands from users to enable the exchange of data between different game titles so that they could enjoy a variety of games, the exchange of parameters between different game titles is difficult due to the different types of parameters and the descriptive language. Thus, the processing of appraising the results of a certain game title and changing the game difficulty of another game title was not possible.

Thus, an object of the present invention is to provide a game information processing system capable of executing a game application with electronic money, and establishing a relationship between electronic money and the game so as to process an added value (game points, etc.) upon executing the game.

Another object of the present invention is to provide a game system comprising a point processing function capable of controlling the mode of point transfer processing more precisely so as to match the entity of the service company.

Yet another object of the present invention is to provide a game system capable of adjusting the game processing characteristics such as the game difficulty between different game titles without having to exchange the control parameters in the game program.

In order to achieve the foregoing object, the first invention provides a game information processing system capable of authorizing the execution of game play with a game application program employing either electric money and/or game points, comprising: a portable apparatus including a non-contact IC circuit having an electronic money storage unit storing the amount of electronic money, a game point storage unit storing the game points, and a data processing unit; an electronic money processing means for outputting to the processing unit, in a non-contact manner, a signal for making the electronic money storage unit add the amount of electronic money that was purchased; a selection means for making a user select whether the settlement for executing the game application program is to be based on the electronic money or the game points; a first settlement processing means for outputting to the data processing unit a signal for subtracting the amount of electronic money or the game points necessary in executing the game application program from the respective storage units of the IC circuit; a point generation means for generating acquired points in accordance with the game execution status; and a second settlement means for outputting to the data processing unit, in a non-contact manner, a signal for adding the acquired game points to the game point storage unit.

In order to achieve the foregoing object, the second invention also provides a game information processing system, comprising: an electronic game terminal; a first memory storing game points generated to the electronic game play; a second memory storing rules for regulating the transfer of game points and service points of other companies between specific companies; a point processing request input terminal for a player to input a point processing request; and a processing board for executing a processing means that executes computation of transferring the game points to the service points of other companies according to the rules based on the point processing request and the game points.

In order to achieve the foregoing object, the third invention also provides a game information processing system, comprising: an electronic game processing means storing game program data; a first memory storing game play log information in the electronic game; a second memory storing a conversion program for converting the log information into influence degree data in relation to other game program data; and a processing board for seeking the influence degree data based on the log information and the conversion program, and reflecting the influence degree data to the other game program data.

In the present invention, electronic money is money in which the monetary value is defined with digital data, and is used for shopping instead of a credit card or cash, or as a settlement means of electronic commerce using the Internet. Among the portable apparatuses which are personal information terminals such as portable phone terminals or IC cards, there are those which enable the recording of monetary value data in a dedicated IC chip. In this IC circuit (IC card, IC chip), added-value data other than electronic money such as game points that are generated as a result of playing the game or visiting the video game arcade, or upon consuming real money in the game machine, or points that are generated by lottery can also be recorded. Since the management terminal (server) of the game points is storing game points that were generated upon settlement necessary in executing the game with electronic money, the player is able to transfer his/her game points to the IC chip.

A game point is a useful data or parameter provided from the provider of the video game arcade, or from the software manufacturer or hardware manufacturer of the game, or generated upon playing a game of a specific title, and, for instance, when a prescribed number of points are accumulated, player may play the game with points without having to use electronic money or real money.

In the present invention, an electronic game terminal is a domestic game machine, business-use game machine, or a personal computer, or it may be a terminal for conducting electronic commerce including Internet shopping. The first memory, second memory, point processing request input terminal and processing board may be provided to the client device or server device in a network constituted from a client-server system. Further, these may be provided to a portable terminal device, or may be distributed to the client device, server device and portable terminal device. This also applies to the third invention.

Game points include the narrowly-defined game points provided upon playing an electronic game, as well as points provided upon engaging in electronic commerce. As a mode of restricting the transfer of points to the point service of another company, there is a positive setting of authorizing the transfer of points with a certain company, and there is a negative setting of not authorizing the transfer of points with a certain company. The positive setting and/or negative setting is described in a processing program in advance.

For example, let it be assumed that this is a case where Company A and Company B are the service companies, and there are game points that were generated in the video game arcade of Company C; provided, however, that Company A and Company B are competing companies, and they are mutually restricting the transfer or exchange of point data. The game points of Company C can be transferred, exchanged or converted into the service points of Company A and the service points of Company B. However, the points of Company A that were transferred and became the points of Company C cannot be transferred to the points of Company B. This also applies to the case of transferring points from Company B via Company C. In order to realize this, an identification symbol may be provided to the points of Company C so as to distinguish whether the points were independently generated by Company C, or are secondary points that passed through the points of other companies. This identification symbol may be set, for example, in a prescribed area of the server.

### BRIEF DESCRIPTION OF THE DRAWINGS

FIG. 1 is a block diagram of the game information processing system according to the present invention;

FIG. 2 is a functional block diagram of the portable phone terminal;

FIG. 3 is a functional block diagram of the game device;

FIG. 4 is a flowchart showing the settlement processing operation for game playing with electronic money and game points;

FIG. 5 is a system block diagram for prohibiting the transfer of points between competing companies;

FIG. 6 is a functional block constitution inside the server having stored thereon a point processing program;

FIG. 7 is a block diagram showing the relationship of the authorization/non-authorization of the transfer of points between a plurality of service providers (companies);

FIG. 8 is a functional block diagram of the server for computing the degree of game influence based on the game log;

FIG. 9 is a flowchart showing the cumulative computation processing of the play log information of the server; and

FIG. 10 is a flowchart showing the computation processing of the degree of game influence of the server.

### DETAILED DESCRIPTION OF THE PREFERRED EMBODIMENTS

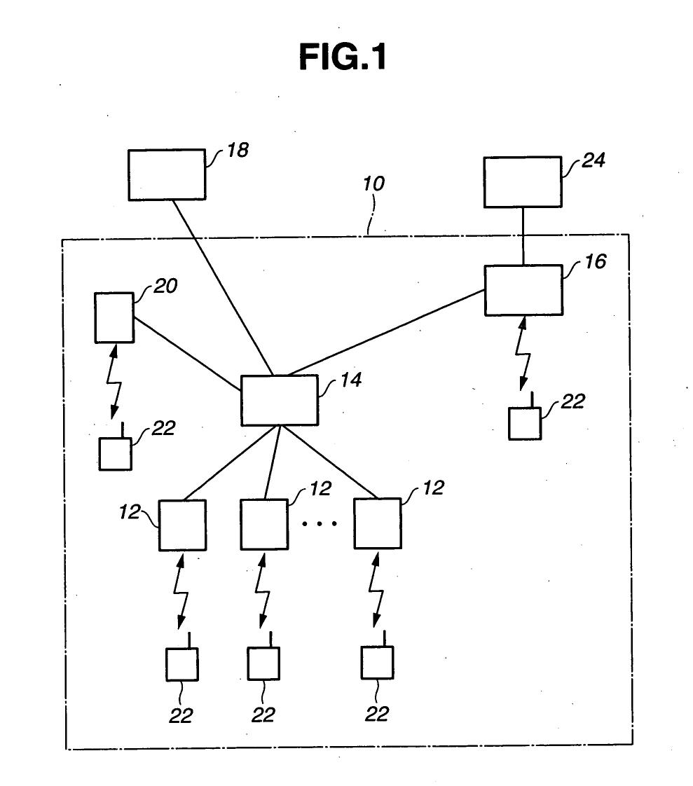

FIG. 1 is a block diagram showing the system according to the present invention. Reference numeral 10 shows the internal system of a store generally referred to as a video game arcade, and this system is constituted from a plurality of game machines 12, a server 14 for such game machines, a purchase terminal 16 of electronic money (e.g., a program referred to as “Edy (trademark)”, an information terminal 20 for the player, and a portable phone (portable apparatus) 22. Outside the store, established are a point server 18 for managing the game points that were generated with a game machine, and an electronic money management server 24.

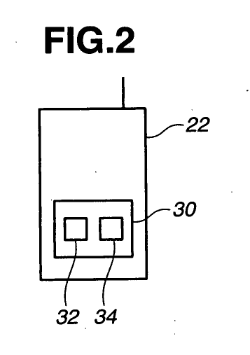

As shown in FIG. 2, the portable phone terminal 22 has a non-contact IC chip 30 (e.g., “FeliCa (trademark)”. This IC chip comprises an electronic money storage unit 32 for storing electronic money information, and a game point storage unit 34 for storing game points. In order to set the electronic money information (amount) purchased by the player from the electronic money information terminal (electronic money processing means) 16 to the storage unit 32, a command for performing such task is communicated, in a non-contact manner, to the microcomputer (data processing unit) inside the portable phone. The data processing means decodes the command and sets the value (electronic money) in the storage unit.

Meanwhile, the player is able to charge the game points from the information terminal 20 to the storage unit 34 as with charging the electronic money information to the storage unit 32. As publicly known, non-contact communication is a method which employs a resonant tag, and is able to write data in the IC chip of the portable terminal or read data out from such IC chip even when the power source of the portable apparatus is turned off.

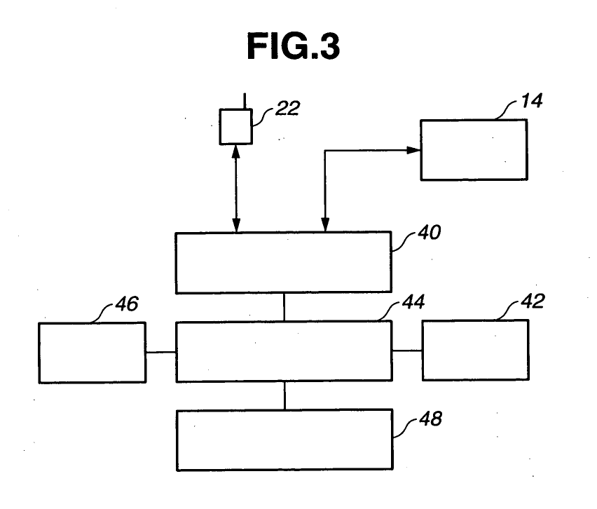

The game machine 12, as shown in FIG. 3, is constituted from a communication module 40 for performing data communication to conduct the settlement (first settlement means) of electronic money or points with the information terminal 22 upon starting the game, a central processing unit 44, a memory 42, a game execution processing unit 46, and a game point generation unit 48.

The central processing unit 44 is constituted from an arithmetic processing device such as a CPU and the operation program thereof, and realizes the function (selection means) of selecting the settlement with electronic money, or the settlement with points. Upon playing the game, the player is able to select whether he/she wants to pay the consideration required for playing the game (¥100 for one game) with electronic money, or with the amount of game points determined to be equivalent to such price. The central processing unit 44 realizes the settlement means (first settlement) with a program for executing these settlements. With this settlement, processing for subtracting the amount of electronic money or amount of game points required for playing the game from the storage data inside the corresponding storage unit is performed.

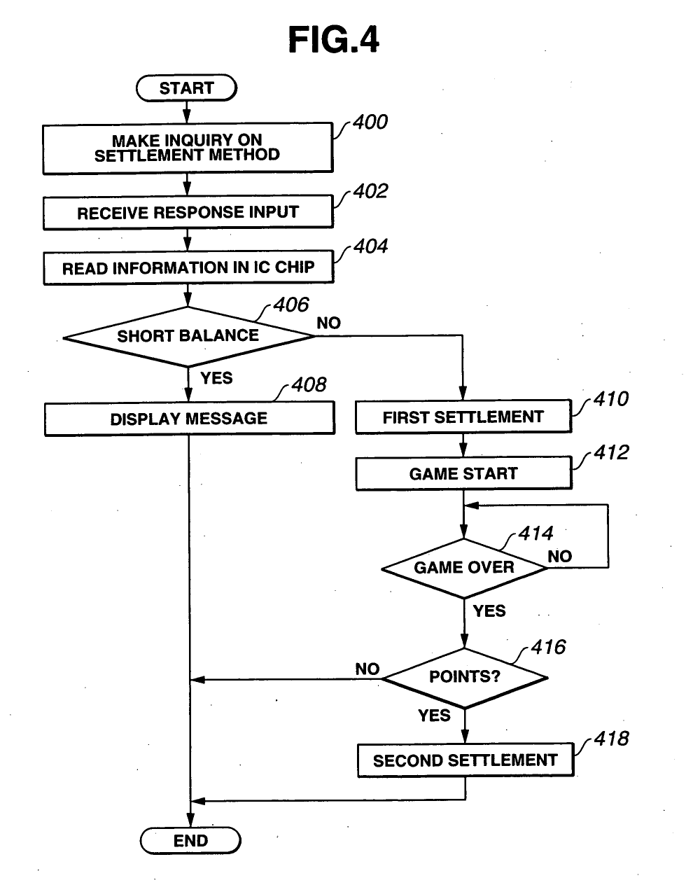

FIG. 4 is a flowchart for showing the data processing operation in the central processing unit. The central processing unit makes an inquiry to the player regarding whether payment is to be made with electronic money, or with game points (400). This is conducted by necessary images being displayed on the monitor. When the player input's an answer (402), and the portable terminal is set to the communication module, the central processing unit reads the information in the IC chip (404), and confirms the balance information of the storage unit (406). When the balance information is insufficient in relation to the price required for executing the game, such message is output and the routine is ended (408). Meanwhile, when the balance information exceeds the required price, the first settlement is conducted (410), and the game pursuant to the game application program stored in the memory is commenced (412). Next, after the game is over (414), it is determined whether points were acquired with the game (416), and, when there are no acquired points, the display to such effect is made to the player as necessary, and the routine is ended thereafter. When there are acquired points, the central processing unit generates the acquired points (point generation means), and communicates an order to the controller of the portable phone terminal, in a non-contact manner via a non-contact communication module, to add the acquired points to the point storage unit. The second settlement of the present invention is realized with this order. After this second settlement is ended, the series of operations is ended.

In FIG. 3, reference numeral 46 is a game execution processing circuit that executed the game based on a game application program, and the progress of game play is displayed on the display device. The game points generation unit 48 generates game points according to the execution status of the game. There is no particular limitation on the generation or acquisition of game points, and may be according to the number of times the game is played with electronic money, or according to each game play or game result, or according to whether the game play was during a special campaign period. This is determined with the point generation program.

Returning to FIG. 1, the points generated with the point generation unit are transmitted to the point management server 18 via the in-shop server 14. A portable apparatus ID and/or a player ID is set in the memory within the point management server 18, and game points are accumulated for each ID. The information terminal 20 in the store is acquiring point information from the management server 18 via the in-shop server 14. It is also possible for the player to set the portable phone 22 in the in-shop information terminal 20, and to charge (second settlement) the acquired points in the memory of the IC chip memory.

The information terminal 20 receives information from the server 18, and provides the player with means for selecting the preferred method of consuming points. In other words, the user may select one's preference of using the points for receiving services related to foods and drinks, or receiving the provision of contents (movies, music). The point management server 18 is connectable with the portable phone 22 via the Internet, and the player may also receive the provision of contents according to the points from the contents server not shown via the Internet.

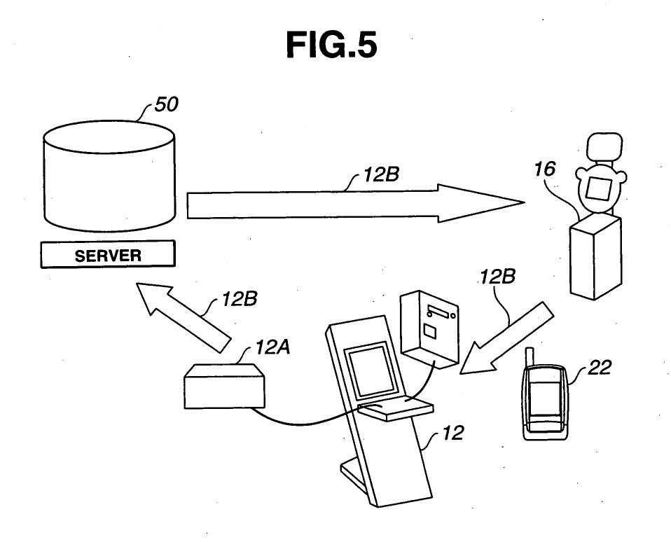

FIG. 5 is a system configuration of the embodiment of the second invention. Components that are the same as the embodiment described above are given the same reference numeral, and the explanation thereof is omitted. Reference numeral 50 is a storage server connected via a game machine server, and a point service database is stored inside this storage server. Reference numeral 12 corresponds to the electronic game terminal, and the first memory storing the game points generated in the electronic game terminal is defined in the memory of the portable terminal 22, and the second memory storing the point processing program having described therein the regulation mode upon transferring the game points to the service points of other companies is defined in a prescribed memory area in the storage server.

The terminal for inputting the player's point processing request is provided to the game machine 12 to which the portable terminal is connected. When this point processing request is made, the processing board (which is provided to the storage server) conducts computation for transferring the game points to the service points of another company according to the point processing program.

This processing result is stored as points of the respective companies in a prescribed storage area inside the storage server. Such points of the respective companies may be set and stored in the memory of the player's portable terminal or the IC card of the respective service companies via the terminal 12 or terminal 16 in the video game arcade. Incidentally, in FIG. 4, reference numeral 12A is the shop router, and reference numeral 12B is a connection via a communication circuit.

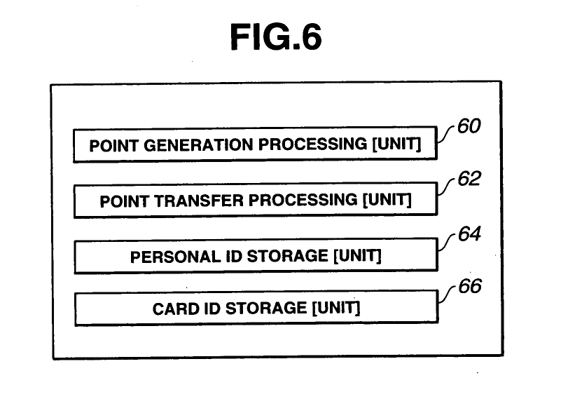

FIG. 6 is a functional block diagram of the point processing program in the server. This [program] comprises a point generation processing [unit] 60 for generating game points, a point transfer processing [unit] 62, personal ID storage unit 64 and a corresponding card ID storage unit 66. The card ID includes the ID of a personally owned portable terminal, and the ID of IC cards corresponding to the services of the respective companies such as the service card ID of Company A, and the service card ID of Company B. The game points are stored in the memory in correspondence with the personal ID, and stored in the memory area linked to the card ID corresponding to the points to be transferred.

There are the following modes upon the generation of points. A certain percentage of points may be generated in Company A, and a certain number of points may be generated in Company B. Here, all of the points generated as a result of the game play may be distributed simultaneously with the generation as described above, or some game points may be retained.

In the second mode, the points in Company A may be set in Company B during a specific period of time. In the third mode, when a certain number of points is acquired in Company A, points that are generated subsequently may be accumulated in Company B. Further, when the points in Company B become a certain number, such points may be returned as points in Company A. In the fourth mode, when a certain number of points is accumulated in Company A, Company B's electronic coupon may be issued by a certain due date. Other modes may be used without any limitation.

The processing mode to be used may be selected by the user with the game terminal for each electronic game played, or by connecting to the storage server via the portable terminal.

Moreover, as another mode, there is a setting relating to the collaboration among the respective service companies. The points in Company A and the points in Company D may be used as the common points of both companies. With the identification symbol set to the points, a prescribed shop or location, or time limit may be set to such points. For example, a plurality of bit flags may be set as the identification symbol, a table in which the flag and limitation information are made to correspond may be prepared, and this table may be shared in a server among the plurality of companies.

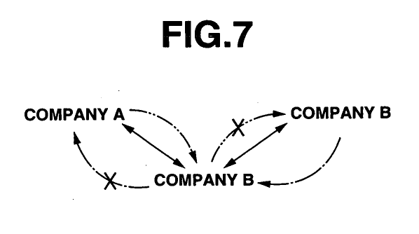

FIG. 7 is a relational diagram of the operating company (C) and the two service companies A and B. Company A and Company B are competing companies, and, let it be assumed that although both Company A and Company B are not desiring the exchange of points, they are desiring the exchange of points with the operating company. The point transfer of C→A, B, and the point transfer of A, B→C are authorized (not restricted). The point transfer of A→C→B is prohibited, and the point transfer of B→C→A is also prohibited. The authorization/non-authorization of such transfer; that is, the rules are defined in a table format, and are set and stored in a prescribed area of the memory as a processing program storage table.

According to these rules, there will be several patters for the combination among companies authorizing the transfer of points upon receiving the rules regarding the prohibition of the transfer of points such as the authorization of transferring points only for C→A, B, authorization of transferring points only for A, B→C, and so on, and these may be set in the foregoing table. These patterns may be made to be selectable. Such selection may be made by the operating company or the service provider. In order to distinguish the authorization/non-authorization, although the points of Company C were generated independently, it is desirable to make a distinction on whether the points when through the service points of other companies. Thus, identification symbols were provided to the points to enable the point generation log described above.

Next, the embodiment of the third invention is explained. In this embodiment, the processing system enables the mutual exchange of information among different equipment such as game machines manufactured by different game machine manufacturers, game machines of different video game arcades, game machines of different titles, or the service provision server or computers of other companies by connecting them to a single network. Further, a server for controlling the clients is provided. Nevertheless, since the game machines and game programs of different manufacturers are respectively different, the game control data and parameters cannot be exchanged, and even is such exchange is possible, it would be limited to an extremely narrow scope. For example, to change the parameter itself that will influence the game program is different since the definition of parameters among game devices of other companies is different.

Thus, in the present invention, as an example of information or a parameter that may be common in the electronic games of the respective companies, a player may use the electronic game implementation log employing the electronic game terminal. The game server connected to the common network stores the log of game play by the user using the game terminal device. For example, this includes the date and time of game play, duration of game play, total number of game play and so on.

Further, let it be assumed that a certain ID is defined, and a game category corresponding to this ID is set. A game category, for example, is the type of game such as sports games, battle games, driving games and so on. The game category may be determined by further classification into baseball or soccer among the sports games. Therefore, as a result of this ID and game category corresponding, this ID is set individually to the game application program. This is stored in the server in the form of a storage table.

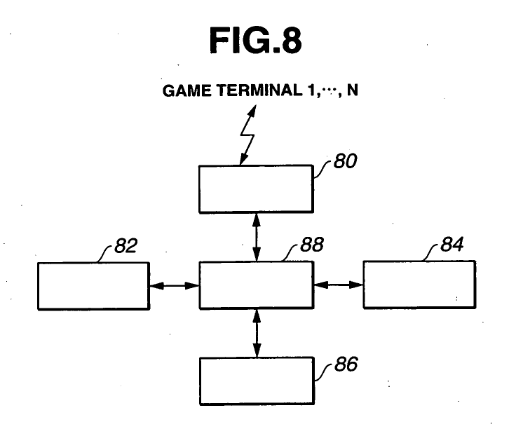

FIG. 8 is a functional block diagram of the server, and existing therein is a processing system 88 comprising a communication device 80 for communicating with the game terminal, a memory 82 having the storage table described above, a memory 84 having accumulated therein the game log of each game device for each user ID, a memory 86 storing a program for computing the degree of game influence from the game log and storage table, and a computation device such as a CPU.

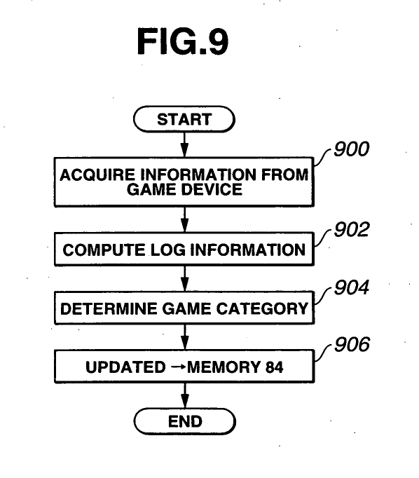

FIG. 9 is a flowchart showing the operation of the server, and when the user accesses the game device and plays the game, the server acquires such information (900). The server calculates from this information the game log such as the duration of game play, date and time of game play, total game play time, latest access date and time, total number of game play and so on for each player ID (902). Next, the processing system of the server reads the ID of the game program from the storage table, and determines the game category data corresponding to this ID. The game category and game log are determined for each user ID, and this is updated and stored in the memory 84 (906). The log information construction processing of the server is ended thereby.

Here, the pattern examples of this stored information will be as follows:
User ID XX
AA Game; Category X; Latest Access [Date, Time]; Total Access: [Count]
BB Game; Category Y; Latest Access [Date, Time]; Total Access: [Count]
CC Game; Category Z; Latest Access [Date, Time]; Total Access: [Count]

The first column is the game title. A category, for instance, is a general classification of the game indicated with a code for a battle game, a code for a baseball game, a code for a soccer game, and so on. Games falling under the same category have empirical rules such as enabling the setting of user's skills in the game from the connection log information and so on. In other words, if the frequency of connection to the baseball game of Company A is high, the skill of the user who accesses the baseball game of other companies should also be high. Thus, in game programs among categories with high association, the skill (difficulty) is computed from the frequency of connection to one of the game programs, and this is reflected to the other game program so as to change the parameter of this game program. This would be much easier in comparison to a case of exchanging the control parameter itself.

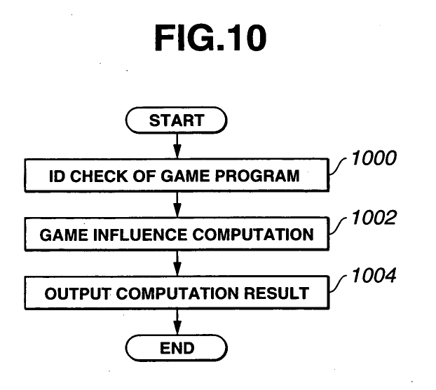

FIG. 10 is a flowchart showing the processing operation of the server for determining the degree of game influence. When the user accesses a certain game terminal, the server checks ID of the game application program of this game terminal (1000).

The processing system of the server accesses the memory 84 and memory 86, and computes the degree of game influence based on the past log information and computation program (1002).

An example of computation is as follows. The degree of association of the category of the past log information and the category of the game device currently being accessed by the user is sought. This may be a function, or the storage table may be referred to. As the degree of category association, 0 or 1 is set, and the higher the degree of association, this is set to “1”, and when there is no association, this is set to “0”. For example, when the games are both baseball games, the degree of category association is set to “1”, when the games are a baseball game and a soccer game, the degree of category association is set to “0.5”, and when the games are a baseball game and a mahjong game, the degree of category association is set to “0”. Even among baseball games, the games can be segmentalized into Japanese Professional Baseball, US Major League Baseball, high school baseball and so on, and the degree of association may be set more narrowly. The table of the degree of category association is stored in a prescribed storage area of the memory. Another computation example is shown below:
{Games Played}=0 to 255 (integral number; max=255 times)
{Latest Access}=0 to 366 (point number when including time; converted as subtraction data from the current date and time; max is 1 year)
Difficulty=0 to 1 (point number); difficulty data is calculated as follows:
Difficulty={games played}÷255×{degree of category association}×(366−{latest access})/366×a

Therefore, the higher the degree of category association, the more recent the latest access, the higher the number of games played, the difficulty data will become higher.

When the server computes the difficulty data, it outputs the result to the game terminal. The game terminal uses this difficulty data and changes the game environment relating to the game difficulty. For example, for users with experience in baseball games, in a game terminal storing the game application program of the same baseball game, the game difficulty is increased so that the user will not become bored of the game. Here, increasing the game difficulty is not merely making the game difficult, and is also creating a game environment that will not be provided to inexperienced users. For example, the amusement of the game is increased by making a special item appear, making a character with a strong parameter setting appear, providing various scenes, increasing the character life value, and so on. Therefore, in the present embodiment, by merely employing a game log, which is data relatively common among the game application programs manufactured by different manufacturers, the past game play can be easily used to influence the game amusement such as the difficulty of the game.

Incidentally, the foregoing memory may be a separate memory device, or may be set in different storage areas of the same device. Further, the degree of game influence may, in addition to influencing the game difficulty, influence the game story or the like.

1. A game information processing system capable of authorizing the execution of game play with a game application program employing either electric money and/or game points, comprising:
a portable apparatus including a non-contact IC circuit having an electronic money storage unit storing the amount of electronic money, a game point storage unit storing said game points, and a data processing unit;
electronic money processing means for outputting to said processing unit, in a non-contact manner, a signal for making said electronic money storage unit add the amount of electronic money that was purchased;
selection means for making a user select whether the settlement for executing the game application program is to be based on said electronic money or said game points;
first settlement processing means for outputting to said data processing unit a signal for subtracting said amount of electronic money or said game points necessary in executing the game application program from the respective storage units of said IC circuit;
point generation means for generating acquired points in accordance with the game execution status; and
second settlement means for outputting to said data processing unit, in a non-contact manner, a signal for adding the acquired game points to said game point storage unit.

2. Said portable apparatus to be used in the system according to claim 1.

3. A portable apparatus according to claim 2 constituted from a portable phone.

4. An electronic money processing terminal to be used in the system according to claim 1 and having said electronic money processing means.

5. An electronic game terminal to be used in the system according to claim 1 having at least said selection means, said first settlement processing means, and said point generation means among the respective means.

6. A server to be used in the system according to claim 1 and storing said game points in relation to a personal ID in relation to said portable apparatus.

7. A server according to claim 6 having settlement terminal means for outputting to said data processing unit, in a non-contact manner, a signal that adds game points in relation to said personal ID to said game point storage unit.

8. A program for making a controller of said portable apparatus execute the settlement of said electronic money and game points based on a signal output from said first and second settlement [means].

9. A game information processing system, comprising:
an electronic game terminal;
a first memory storing game points generated to the electronic game play;
a second memory storing rules for regulating the transfer of game points and service points of other companies between specific companies;
a point processing request input terminal for a player to input a point processing request; and
a processing board for executing a processing means that executes computation of transferring said game points to said service points of other companies according to said rules based on the point processing request and said game points.

10. A system according to claim 9, wherein said second memory contains the combination of said specific companies authorized to transfer said points.

11. A game information processing system, comprising:
an electronic game processing means storing game program data;
a first memory storing game play log information in the electronic game;
a second memory storing a conversion program for converting the log information into influence degree data in relation to other game program data; and
a processing board for seeking said influence degree data based on said log information and said conversion program, and reflecting the influence degree data to said other game program data.

12. A system according to claim 11, wherein said processing board has a processing means that performs processing so as to change said influence degree data based on the size of the relevance ratio of said game programs.

13. A system according to claim 12 having a third memory containing a storage area wherewith a game category for each of said game programs is determined therein.

14. A system according to claim 13 having a fourth memory containing a storage area wherewith a parameter for seeking said influence degree data is set therein in relation to the combination of the game program category.

15. An electronic game terminal having said electronic game processing means to be used in the system according to any one of claims 9 to 14.

16. An electronic game terminal according to claim 15 having the respective memories and the processing board of the system according to any one of claims 9 to 14.

17. A server to be connected to a plurality of electronic game terminals according to claim 15 via a communication line having the respective memories and the processing board of the system according to any one of claims 9 to 14.

18. A program for making the processing board execute the processing means according to claim 9.
